(19) United States
(12) Patent Application Publication
(10) Pub. No.: US 2008/0318508 A1
(43) Pub. Date: Dec. 25, 2008

(54) Microbe-Resistant Hair Removal Paddle

(76) Inventors: Ernst-August Meier, Bad Salzdetfurth (DE); Detlef Karge, Brietlingen (DE)

Correspondence Address: COLLARD & ROE, P.C., 1077 NORTHERN BOULEVARD, ROSLYN, NY, 11576, US

(21) Appl. No.: 10/579,964

(22) PCT Filed: May 27, 2005
(86) PCT No.: PCT/DE05/00956

§ 371 Date: May 19, 2006

(30) Foreign Application Priority Data
Feb. 4, 2005 (DE) 10 2005 004 979.6

(51) Int. Cl. A22B 5/08

(52) U.S. Cl. 452/97

(57) ABSTRACT

The invention relates to a hair removal paddle (1), comprising a base body (2) made of polymer material, as well as metallic additional components (e.g. scrapers 4, 5) as part of a slaughtering line, particularly for slaughtering pigs, whereby the polymer material is, in particular, a vulcanized rubber mixture, comprising a rubber component as well as mixture ingredients, whereby according to the invention, an active inhibitor is mixed into the polymer material, which prevents the growth of microorganisms.

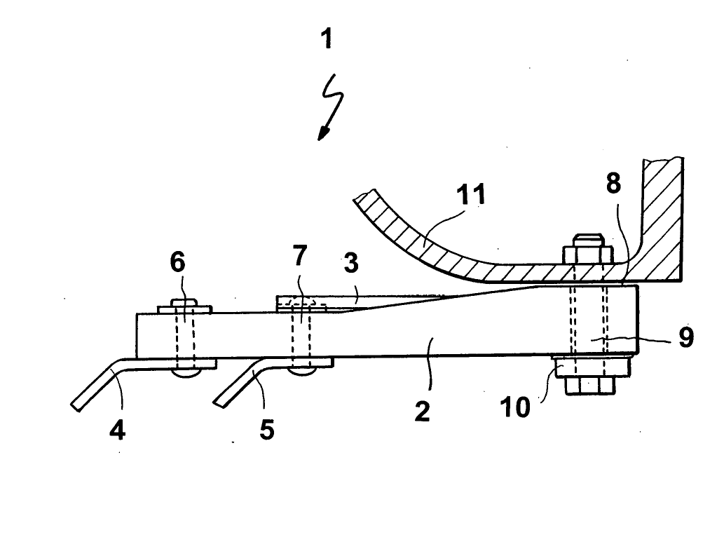

In connection with microbe resistance, advantageous rubber components are also presented.

The invention relates to a hair removal paddle, comprising a base body made of polymer material, as well as metallic additional components, as part of a slaughtering line, particularly for slaughtering pigs, whereby the polymer material is, in particular, a vulcanized rubber mixture, comprising a rubber component as well as mixture ingredients.

A hair removal paddle of the type stated is described in greater detail in the following references, for example: U.S. Pat. No. 15,318; U.S. Pat. No. 2,604,656; U.S. Pat. No. 4,907,317; and EP 0 665 717 B1.

The elastic base body of the hair removal paddle has an embedded strength support in the form of woven fabric or fibers, in most cases. In this connection, it can be equipped with or without stress relief grooves. A particularly proven design is presented in the patent EP 0 665 717 B1, according to which the base body of the hair removal paddle is provided with a baffle stool and stress relief grooves. The metallic additional components are scrapers, attachment elements, and a stop.

A problem point is the growth of microorganisms (bacteria, microbes) during the hair removal process, particularly since the hot water is re-circulated several times. The maximal permissible limit of microorganisms is frequently exceeded. Even if all measures of hygiene and health are taken in a slaughtering operation, the accumulation of microorganisms results in destruction of the polymer material and therefore in failure of the hair removal paddle.

With the background of the problems indicated above, the new hair removal paddle is characterized, independent of its design, in that an active inhibitor is mixed into the polymer material, which prevents the growth of microorganisms. In connection with this goal, the inhibitor is also referred to as a microorganism inhibitor.

The inhibitor is, in particular, difficult to dissolve in water. In this manner, the inhibitor is prevented from washing out.

Particularly effective inhibitors, also under the aspect of the aforementioned low solubility, are:
2,4,4′-trichloro-2′-hydroxy diphenyl ether:
N′-tert.butyl-N-cyclopropyl-6-(methylthio)-1,3,5-triazine-2,4-diamine.

Within the scope of an advantageous variant, a carrier that is charged with the inhibitor is mixed into the polymer material, specifically with the formation of a carrier/inhibitor adduct. The carrier material is, in particular, a molecular sieve in the form of a metal-aluminum silicate having the following formula:

Meₙ[(AlO₂)ₓ.(SiO₂)_{y}] with or without water of crystallization, particularly

Na₈₆[(AlO₂)₈₆.(SiO₂)₁₀₆] with or without water of crystallization

A metal-aluminum silicate that is frequently used is:

Na₈₆[(AlO₂)₈₆.(SiO₂)₁₀₆].276H₂O

In this connection, the water of crystallization is dehydrogenated, either in whole or in part. The water of crystallization spaces that become free within the metal-aluminum silicate lattice are then taken up by means of charging them with the inhibitor. Then, the corresponding adduct is effective.

Alternatively to this, the carrier can also consist of fibers, for example polyamide, polyester, or cellulose fibers, which are charged with the inhibitor, specifically with the formation of a fiber/inhibitor adduct.

The carrier of the adduct, in each instance, has reinforcement properties in addition to its charging function, so that the classical reinforcement in the form of a woven fabric can be eliminated. The adduct binds the inhibitor (delayed release effect), on the one hand, while on the other hand, it ensures a controlled biochemical mechanism of effect having a long-term effect.

The inhibitor or the adduct is distributed in the polymer material essentially in uniform manner. Its proportion with reference to the total mass of the polymer material is, in particular, 0.1 to 10 wt.-%, particularly 0.5 to 5 wt.-%.

The polymer material is low in plasticizer, preferably free of plasticizer, whereby the following rubber components are used in connection with a vulcanized rubber mixture:
The rubber component is an ethylene-propylene-diene mixed polymerizate (EPDM) or nitrile rubber (NBR), particularly an EPDM/NBR blend.
The rubber component is silicone rubber, butyl rubber (IIR), chlorobutyl rubber (CIIR), or bromobutyl rubber (BIIR), which are non-blended, in each instance.

With reference to the total mass of the polymer material, the proportion of the polymer or rubber or blend component, respectively, is 10 to 70 wt.-%, particularly 30 to 70 wt.-%. The optimal material constellation exists at a proportion of 40 to 55 wt.-%.

The rubber mixture usually has a filler or filler system on the basis of carbon black and/or silicic acids and/or silicates and/or chalk. In particular, a filler system on the basis of carbon black, magnesium silicate, and chalk is used.

Other usual mixture ingredients are a cross-linking agent (e.g. sulfur or sulfur donator) and/or vulcanization activator (e.g. zinc oxide) or cross-linking system, processing aids (e.g. stearic acid), as well as anti-aging agents and stabilizers, if necessary. In this regard, reference is made to the general state of rubber mixture technology. In particular, zinc oxide (vulcanization activator) and zinc N-dibenzyl-dithiocarbamate (accelerator ZBEC) is used as a cross-linking agent system comprising a cross-linking agent and/or vulcanization activator.

In addition to the usual mixture ingredients indicated above, the adducts already presented in greater detail can be used as additional mixture ingredients.

The invention will now be explained in greater detail using an exemplary embodiment, making reference to a schematic drawing.

The hair removal paddle 1 comprises a base body 2 made of polymer material, which is essentially rectangular. Within its back the base body is provided with a baffle stool 3, which is configured in one piece with the base body. At its front, the hair removal paddle is equipped with angle-shaped scrapers 4 and 5, made of metal, whereby their anchoring takes place by means of a bore and a rivet connection 6 and 7, in each instance. The base body is furthermore firmly anchored in the screw-on region 8 by means of a bore and a screw/bolt system 9 as well as a clamping plate 10. Furthermore, the hair removal paddle is provided with a stop 11. Other design details, particularly in connection with stress-relief grooves, are mentioned in the patent EP 0 665 717 B1.

An active inhibitor is mixed into the base body 2 made of polymer material, particularly on the basis of a vulcanized rubber mixture (elastomer), which inhibitor prevents the growth of microorganisms. In this regard, the following two variants are now being presented:
The base body 2 of the hair removal paddle 1 has a center strength support in the form of a continuous woven fabric, specifically with the formation of an upper layer and a lower layer of the base body, as is the case for conveyor belts or hoses that are reinforced with woven fabric. The inhibitor is mixed into the upper and lower layer without any additional carrier, specifically with a distribution that is essentially uniform within each layer.
The base body 2 is not reinforced with woven fabric. Instead, it is provided with a carrier/inhibitor adduct, whereby the molecular sieve/inhibitor adduct or the fiber/inhibitor adduct, in particular, are used. Here again, the adduct is distributed in essentially uniform manner. Here, the carrier takes on the strength support function, at the same time.

### REFERENCE SYMBOL LIST

1 hair removal paddle
2 base body
3 baffle stool
4 scraper
5 scraper
6 rivet connection
7 rivet connection
8 screw-on region
9 screw/bolt system
10 clamping plate
11 stop

1. Hair removal paddle (1), comprising a base body (2) made of polymer material, as well as metallic additional components (4, 5, 6, 7, 9, 10, 11) as part of a slaughtering line, particularly for slaughtering pigs, whereby the polymer material is, in particular, a vulcanized rubber mixture, comprising a rubber component as well as mixture ingredients, wherein an active inhibitor is mixed into the polymer material, which prevents the growth of microorganisms.

2. Hair removal paddle according to claim 1, wherein the inhibitor is difficult to dissolve in water.

3. Hair removal paddle according to claim 1, wherein a carrier that is charged with the inhibitor is mixed into the polymer material, specifically with the formation of a carrier/inhibitor adduct.

4. Hair removal paddle according to claim 3, wherein the carrier is a molecular sieve, particularly on the basis of a sodium-aluminum silicate, specifically with the formation of a molecular sieve/inhibitor adduct.

5. Hair removal paddle according to claim 3, wherein the carrier consists of fibers, specifically with the formation of a fiber/inhibitor adduct.

6. Hair removal paddle according to claim 1, wherein the inhibitor is distributed in the polymer in essentially uniform manner.

7. Hair removal paddle according to claim 1, wherein the proportion of the inhibitor, with reference to the total mass of the polymer material is 0.1 to 10 wt.-%.

8. Hair removal paddle according to claim 7, wherein the proportion of the inhibitor is 0.5 to 5 wt.-%.

9. Hair removal paddle according to claim 1, wherein the polymer material is low in plasticizer, particularly free of plasticizer.

10. Hair removal paddle according to claim 1, wherein the rubber component is an ethylene-propylene-diene mixed polymerizate (EPDM) or nitrile rubber (NBR), particularly an EPDM/NBR blend.

11. Hair removal paddle according to claim 1, wherein the rubber component is silicone rubber.

12. Hair removal paddle according to claim 1, wherein the rubber component is butyl rubber (IIR).

13. Hair removal paddle according to claim 1, wherein the rubber component is a halogenated rubber.

14. Hair removal paddle according to claim 13, wherein the halogenated rubber is chlorobutyl rubber (CIIR) or bromobutyl rubber (BIIR).

15. Hair removal paddle according to claim 11, wherein the rubber component is non-blended.

16. Hair removal paddle according to claim 1, wherein with reference to the total mass of the polymer material, the proportion of the polymer or rubber or blend component, respectively, is 10 to 70 wt.-%, particularly 30 to 70 wt.-%.

17. Hair removal paddle according to claim 16, wherein the proportion of the polymer or rubber or blend component, respectively, is 40 to 55 wt.-%.
